(19) United States
(12) Patent Application Publication
(10) Pub. No.: US 2005/0144459 A1
(43) Pub. Date: Jun. 30, 2005

(54) Network security system and method

(75) Inventors: Khurshid Qureshi, Colorada Springs, CO (US); Nadir Nizmuddin, Colorado Springs, CO (US)

Correspondence Address: LAW OFFICE OF DALE B. HALLING, 24 s. WEBER ST., SUITE 311, COLORADO SPRINGS, CO, 80903, US

(73) Assignee: ZeeWaves Systems, Inc.

(21) Appl. No.: 11/012,776

(22) Filed: Dec. 15, 2004

Related U.S. Application Data
(60) Provisional application No. 60/529,471, filed on Dec. 15, 2003.
(60) Provisional application No. 60/529,653, filed on Dec. 15, 2003.

(51) Int. Cl. H04L 9/00

(52) U.S. Cl. 713/176

(57) ABSTRACT

A network security system has a terminal access authentication system with a physical key for mutual authenticating a terminal. A frame authentication system is coupled to the terminal and authenticates each frame sent from the terminal.

### RELATED APPLICATIONS

The present invention claims priority on provisional patent application Ser. No. 60/529,471, filed on Dec. 15, 2003, entitled “Secure Ethernet” and on provisional patent application Ser. No. 60/529,653, filed on Dec. 15, 2003, entitled “Network Security System”.

### FIELD OF THE INVENTION

The present invention relates generally to the field of computer networks and more particularly to a network security system and method.

### BACKGROUND OF THE INVENTION

Security for Local Area Networks (LAN) and Wide Area Networks (WAN) is major concern for organizations. This problem has become worse with the spread of Wireless Networks and Wireless Hotspots where hacker can grab the wireless data or intrude in the Network to steal the important information. A Code called Wireless Equivalency Protocol (WEP) used by most individuals and organizations has been broken and its cracking code is openly available. Virtual Private Network (VPN) is hard to configure and difficult to use. One problem with the security of networks is unauthorized users access a network. One solution has been to require user IDs and passwords to access a network. Since these are commonly sent in the clear, they can be intercepted by hackers. Even if the password and ID are encrypted this may be stolen and copied and used to gain access to the network. Digital certificates can also be stole and cloned. Another security problem that occurs in networks is that once a terminal, which may be computer, personal digital assistant (PDA), cell phone or other networked device, has been granted access to the network there is no way of verifying that the authenticated terminal is actually transmitting the associated frames.

Thus there exists a need for a network security system that has an access authentication system that cannot be spoofed by coping passwords and IDs and that verifies that the authenticated terminal is actually transmitting the associated frames. This Network authentication system works in addition to the other network security products and systems and provides an extra layer of security for mutual authentication and packets security and integrity.

### SUMMARY OF INVENTION

A network security system that overcomes these and other problems has a terminal access authentication system with a physical key for authenticating a terminal. A frame authentication system is coupled to the terminal and authenticates each frame sent from the terminal and key exchange protocol. The terminal access authentication system may have an authentication server. The authentication server may have an authorization database containing a copy of the physical key. The terminal may have a dynamic key. The terminal and the authentication server may perform a mutual authentication. The frame authentication system may include an authenticator that is separate from the terminal or a receiver. The authenticator may convert a signed frame into an unsigned standard frame. The authenticator may forward the unsigned standard frame to a destination. The frame authentication system may include a signature algorithm operating on the terminal. The signature algorithm may calculate a partial cyclical redundancy code of a frame.

In one embodiment, a network security method includes the steps of encrypting a physical key at a station with a dynamic encryption key to form an encrypted physical key. The encrypted physical key is transmitted to an access authentication server. The encrypted physical key is decrypted to form a decrypted key. When the decrypted key matches a stored key, a new dynamic key may be transmitted to the station. When the decrypted key matches a stored key at the access authentication server, a server physical key is encrypted using a server dynamic key to form an encrypted server physical key. The encrypted server physical key is transmitted to the station. The encrypted server physical key is decrypted to form a decrypted server physical key. The decrypted server physical key is compared to a stored server key. When the decrypted server physical key matches the stored server key, a signature algorithm is used to form a signed frame. The signed frame is encrypted to form an encrypted signed frame. The encrypted signed frame may be transmitted to a frame authenticator. The encrypted signed frame is decrypted to recover a decrypted signature. The decrypted signature is compared to a stored signature. When the decrypted signature is the same as the stored signature, an unsigned standard frame is transmitted to a destination.

In one embodiment, a network security method includes the steps of creating a signed frame at a transmitting station. The signed frame is received at a frame authenticator. When a signature of the signed frame is authentic, an unsigned standard frame is transmitted to a receiving station. A partial cyclical redundancy code is calculated for a frame to form a signature. The frame and the signature are encrypted to form the signed frame. When the signature of the signed frame is not authentic, the signed frame may be discarded. The transmitting station's identity may be authenticated before receiving access to a network. A physical key at the transmitting station may be encrypted with a dynamic encryption key to form an encrypted physical key. The encrypted physical key is transmitted to an access authentication server. The encrypted physical key is decrypted to form a decrypted key.

### BRIEF DESCRIPTION OF THE DRAWINGS

FIG. 1 is a block diagram of a network security system in accordance with one embodiment of the invention;

FIG. 2 is a block diagram of a network security system in accordance with one embodiment of the invention;

FIG. 3 is a block diagram of a network security system in accordance with one embodiment of the invention;

FIG. 4 is a block diagram of a network security system in accordance with one embodiment of the invention;

FIG. 5 is a flow diagram of the steps used in a network security method in accordance with one embodiment of the invention; and

FIG. 6 is a flow diagram of the steps used in a network security method in accordance with one embodiment of the invention.

### DETAILED DESCRIPTION OF THE DRAWINGS

The network security system and method described herein authenticates any terminal requesting access to the network and then authenticates every frame of data sent from the terminal. In this way the terminal's right to access the network is constantly verified. This system cannot be spoofed by coping passwords and IDs and verifies that the authenticated terminal is actually transmitting the associated frames.

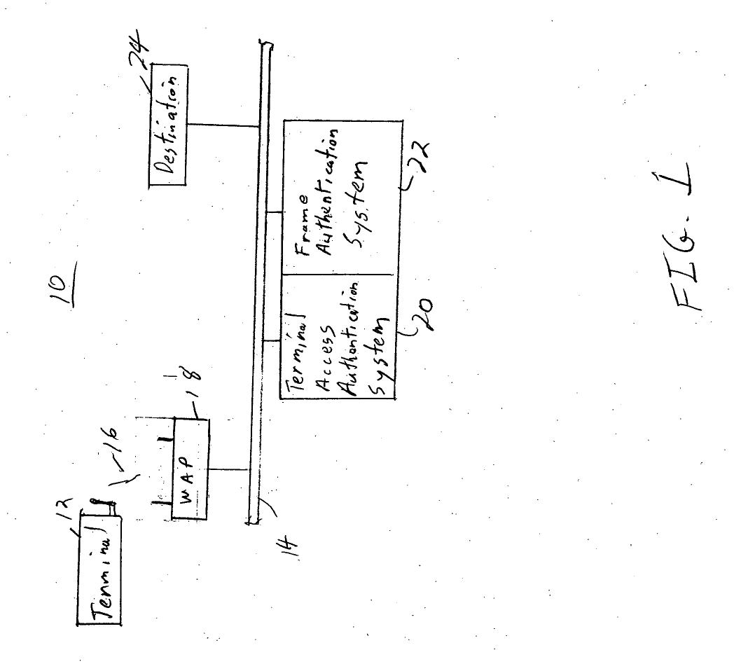

FIG. 1 is a block diagram of a network security system 10 in accordance with one embodiment of the invention. The system 10 has a terminal 12, which may be a computer, PDA (Personal Digital Assistant), cellular telephone or other network device, requesting access to the network 14. In this example, the terminal 12 is requesting access over a wireless channel 16. However, other methods of accessing the network are contemplated by the invention and are well know to those skilled in the art. The terminal 12 connects into the network 14 through a wireless access point 18. The wireless access point 18 is coupled through the network to a terminal access authentication system 20, a frame authentication system 22 and a destination terminal 24. The terminal access authentication system 20 ensures that terminal 12 is authorized to have access to the network 14. The frame authentication system 22 authenticates every frame sent from the terminal 12. Note that the terminal access authentication system 20 and the frame authentication system 22 may be combined and may be part of another device such as a gateway or the wireless access point 18.

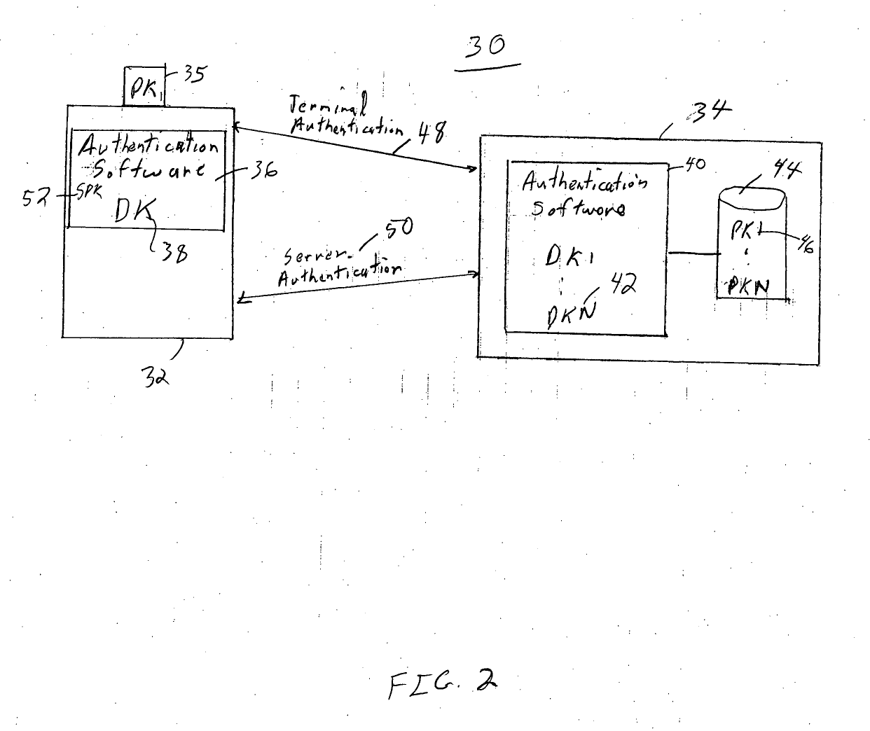

FIG. 2 is a block diagram of a network security system 30 in accordance with one embodiment of the invention. The system 30 has a terminal 32 requesting access to a network and an authentication server 34. The terminal 32 is coupled to a physical key 35 or key code. The physical key may be embedded within a PCMCIA network card, CD-ROM, a floppy drive, laptop or any other media such as USB memory stick, floppy disc, PCMCIA card or embedded in the device. The terminal also has authentication software 36 that contains or has access to a dynamic key 38. The authentication server 34 has authentication software 40 that has access to a number of dynamic keys 42. The authentication software 40 is coupled to a database 44 that contains copies of the physical keys 46 of all terminals authorized to access the network. The key dynamic key exchange program resides on the physical key and on the authentication server When the terminal 32 wants to gain access to the network it sends a “hello” message that lets the authentication server 34 know that it wants access to the network. The authentication server 34 responds with a “challenge” message that requests terminal 32 to send an authentication code. The terminal 32 encrypts the physical key (PK1) 35 using the dynamic key (DK) 38 to form the encrypted physical key. The encrypted physical key is transmitted to the authentication server 34. The authentication server 40 using its authentication software decrypts the physical key using a copy of the dynamic key 42 it has previously stored. The authentication server 34 then compares the decrypted physical key with a copy of the physical key 46 in the database 44. If there is a match, the authentication server transmits and “acknowledge” message that lets the terminal 32 know it has been given access to the network. If there is not a match, the authentication server transmits a “not acknowledged” message that lets the terminal 32 know it is not being given access to the network. These steps constitute the terminal authentication process 48.

In one embodiment, once the terminal has been authenticated it authenticates the server 50. The server 34 encrypts a server physical key 42 to form an encrypted server physical key. The encrypted server physical key is transmitted to the terminal 32. The terminal 32 decrypts the encrypted server physical key using the stored dynamic key 38. If the decrypted server physical key matches a stored server physical key 52, the server has been authenticated and normal communication can proceed. When the terminal 32 also authenticates the server 34, this is called mutual authentication. Once the authentication process is complete the server 34 sends the terminal a new dynamic key. As a result, the authentication message 48 is never the same. This makes it virtually impossible to detect the dynamic code and, in turn, the key code or physical key. In one embodiment the physical key is not directly encrypted, it is first scrambled by an algorithm known to both the server 34 and the terminal 32.

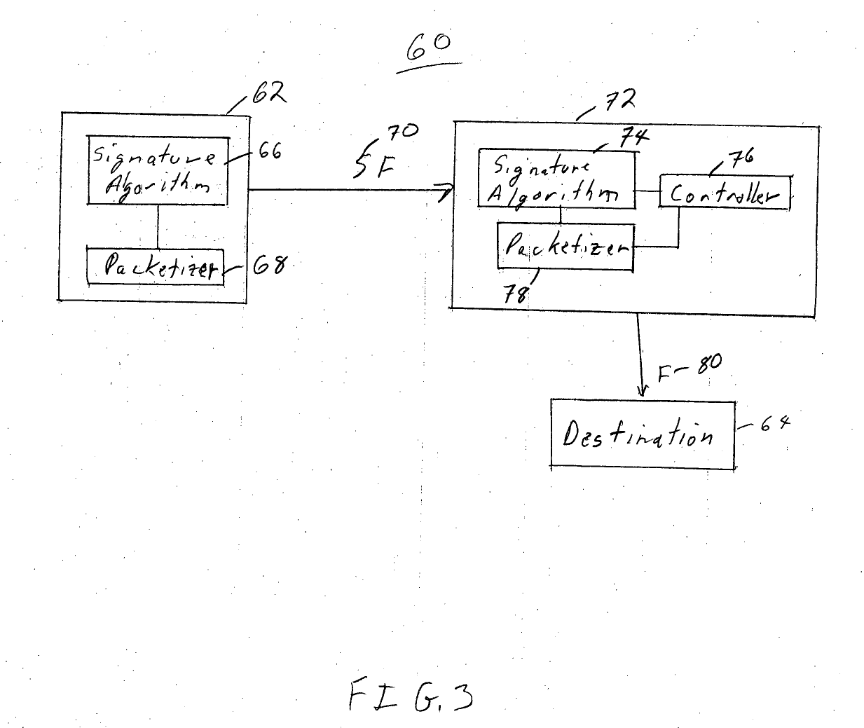

FIG. 3 is a block diagram of a network security system 60 in accordance with one embodiment of the invention. The system 60 has an offsite terminal 62 attempting to send information to a destination device 64 on the protected network. The terminal 62 has a signature algorithm 66 coupled to a packetizer 68. When the terminal 62 is going to send a packet or frame of data, the signature algorithm creates a signature. In one embodiment, the signature is created by calculating a CRC (cyclical redundancy code) of part of the outgoing frame. This partial CRC is placed in the frame by the packetizer 68 to form a signed frame 70. The signed frame 70 is received by a frame authenticator 72. The authenticator 72 has a signature algorithm 74 that calculates what the signature should be. If the transmitted and calculated signatures match, the controller 76 directs the packetizer 78 to create an unsigned frame from the transmitted signed frame 70. The unsigned frame 80 is then transmitted to its network destination 64. If the transmitted and calculated signatures do not match, the frame is discarded. Note that while a partial CRC is one way of creating a signature, there are a number of methods of creating signature including other encoding schemes. All these methods of creating a signature are contemplated for use by the invention.

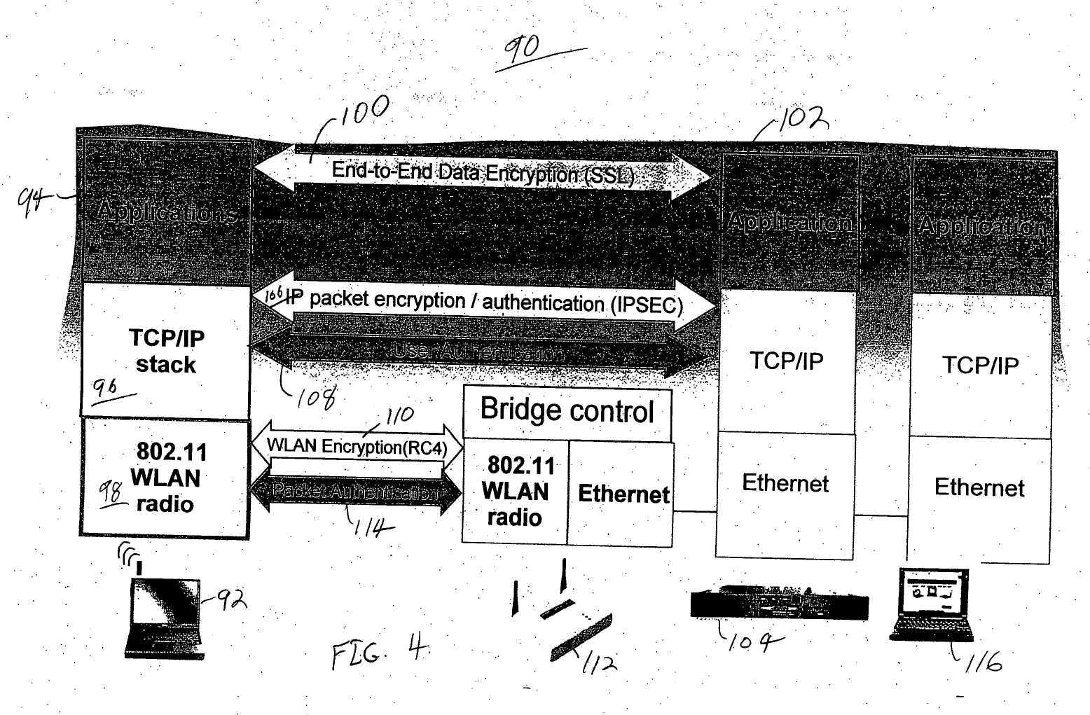

FIG. 4 is a block diagram of a network security system 90 in accordance with one embodiment of the invention. The figure shows the software layers that may be used in the present invention. The terminal 92 requesting access to the network is shown as having an application layer 94, a communication layer 96 and a physical layer 98. Note that the physical layer 98 in this example is the wireless network standard IEEE 802.11 however other physical layers may be used. The applications layer 94 may use an encryption scheme such as Secure Socket Layer (SSL) 100. This encryption scheme is between the application layer 94 of the terminal 92 and the application layer 102 of the frame authenticator 104. The communication layer 96 of the terminal 92 is shown as TCP/IP (Transmission Control Protocol/Internet Protocol) although other transmission layer systems may be used. At this level IP packet encryption and authentication 106 may be used. In addition, the present invention adds a user or terminal authentication system 108. At the physical layer 98 a wireless LAN encryption system (RC4) 110 may be used between the terminal 98 and the wireless access point 112. The present invention, adds the packet authentication system 114. The authenticator 104 is coupled by the network to the destination terminal 116. The WAP 112 only operates at the physical level, while the authenticator 102 and destination terminal 116 both have application layers, communication layers and physical layers.

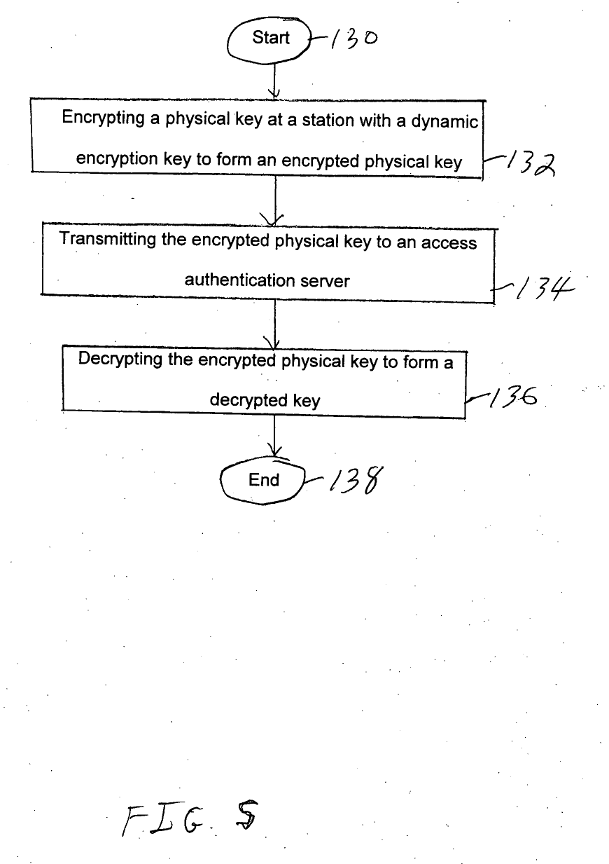

FIG. 5 is a flow diagram of the steps used in a network security method in accordance with one embodiment of the invention. The process starts 130 by encrypting a physical key at a station with a dynamic encryption key to form an encrypted physical key at step 132. The encrypted physical key is transmitted to an access authentication server 134. At step 136 the encrypted physical key is decrypted which ends the process at step 138.

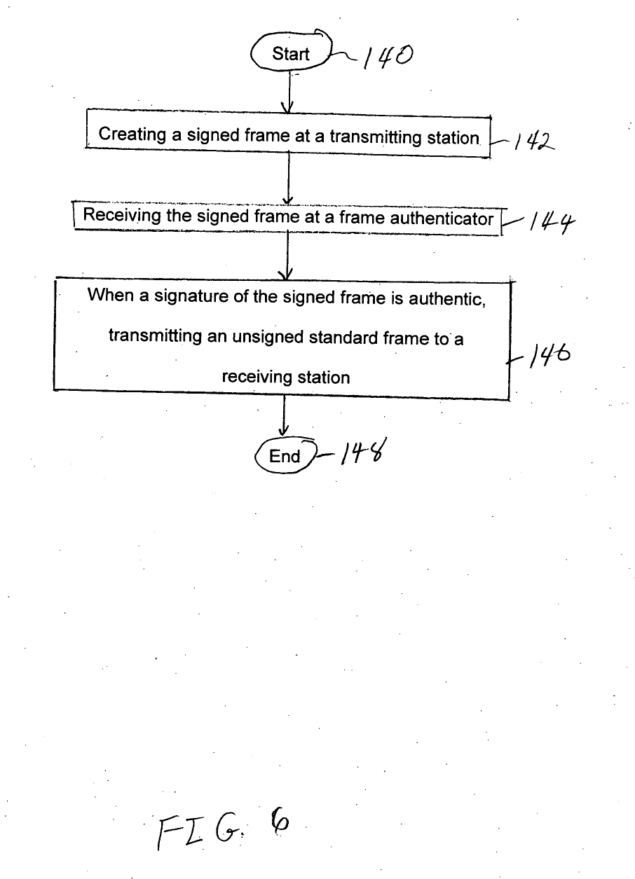

FIG. 6 is a flow diagram of the steps used in a network security method in accordance with one embodiment of the invention. The process starts, step 140, by creating a signed frame at a transmitting station at step 142. The signed frame is received at a frame authenticator at step 144. When a signature of the signed frame is authentic at step 146, an unsigned standard frame is transmitted to a receiving station which ends the process at step 148.

The system and method for network security are easy to use. The terminal authentication software and the frame authentication software may be downloaded onto the computer and server from a website in one embodiment. The key exchange protocol can be downloaded from a secured website. To start using the software, the only other step necessary is to procure a physical key. No other configuration of the systems is necessary. As a result, the easy of use of the security system significantly enhances its chance of being used over other more complicated solutions.

Thus there has been described a network security system and method that cannot be spoofed by coping passwords and IDs and that verifies that the authenticated terminal is actually transmitting the associated frames.

The methods described herein can be implemented as computer-readable instructions stored on a computer-readable storage medium that when executed by a computer will perform the methods described herein.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

1. A network security system, comprising:
a terminal access authentication system having a physical key for mutually authenticating a terminal; and
a frame authentication system coupled to the terminal and authenticating each frame sent from the terminal.

2. The system of claim 1 wherein the terminal access authentication system has an authentication server.

3. The system of claim 2, wherein the authentication server has an authorization database containing a copy of the physical key.

4. The system of claim 3, wherein the terminal has a dynamic key.

5. The system of claim 2, wherein the terminal and the authentication server perform a mutual authentication.

6. The system of claim 1, wherein the frame authentication system includes an authenticator that is separate from the terminal or a receiver.

7. The system of claim 6, wherein the authenticator converts a signed frame into an unsigned standard frame.

8. The system of claim 7, wherein the authenticator forwards the unsigned standard frame to a destination.

9. The system of claim 1, wherein the frame authentication system includes a signature algorithm operating on the terminal.

10. The system of claim 1, wherein the signature algorithm calculates a partial cyclical redundancy code of a frame.

11. A network security method, comprising the steps of:
a) encrypting a physical key at a station with a dynamic encryption key to form an encrypted physical key;
b) transmitting the encrypted physical key to an access authentication server; and
c) decrypting the encrypted physical key to form a decrypted key.

12. The method of claim 11, further including the steps of:
d) when the decrypted key matches a stored key, transmitting a new dynamic key to the station.

13. The method of claim 11, further including the steps of:
d) when the decrypted key matches a stored key at the access authentication server, encrypting a server physical key using a server dynamic key to form an encrypted server physical key;
e) transmitting the encrypted server physical key to the station;
f) decrypting the encrypted server physical key to form a decrypted server physical key;
g) comparing the decrypted server physical key to a stored server key.

14. The method of claim 13, further including the steps of:
h) when the decrypted server physical key matches the stored server key, using a signature algorithm to form a signed frame;
g) encrypting the signed frame to form an encrypted signed frame.

15. The method of claim 14, further including the steps of:
h) transmitting the encrypted signed frame to a frame authenticator;
i) decrypting the encrypted signed frame to recover a decrypted signature;
j) comparing the decrypted signature to a stored signature;
k) when the decrypted signature is the same as the stored signature, transmitting an unsigned standard frame to a destination.

16. A network security method, comprising the steps of:
a) creating a signed frame at a transmitting station;
b) receiving the signed frame at a frame authenticator;
c) when a signature of the signed frame is authentic, transmitting an unsigned standard frame to a receiving station.

17. The method of claim 16, wherein step (a) further includes the steps of:
a1) calculating a partial cyclical redundancy code for a frame to form a signature;
a2) encrypting the frame and the signature to form the signed frame.

18. The method of claim 16, further including the step of:
d) when the signature of the signed frame is not authentic, discarding the signed frame.

19. The method of claim 16, wherein step (a) further including the step of:
a1) authenticating an access to a network of the transmitting station.

20. The method of claim 19, wherein step (a1) includes the steps of:
i) encrypting a physical key at the transmitting station with a dynamic encryption key to form an encrypted physical key;
ii) transmitting the encrypted physical key to an access authentication server; and
iii) decrypting the encrypted physical key to form a decrypted key.

21. An authentication system according to claim 1 where physical key can reside on any of the media such as USB memory stick, floppy disc, PCMCIA card or embedded in the device.

22. An authentication system where the key dynamic key exchange program resides on the physical key and on the authentication server.

23. An authentication system where key exchange protocol can be downloaded from a secured website.
